(19) United States
(12) Patent Application Publication
(10) Pub. No.: US 2025/0371187 A1
(43) Pub. Date: Dec. 4, 2025

(54) SYSTEM AND METHOD OF PROTECTION AGAINST EMBEDDING INVERSION ATTACK IN RETRIEVAL AUGMENTED GENERATION

(71) Applicant: Rubrik, Inc., Palo Alto, CA (US)

(72) Inventors: Seungyeop Han, San Jose, CA (US); Adam Gee, Palo Alto, CA (US); Logan Short, Saratoga, CA (US)

(21) Appl. No.: 18/677,751

(22) Filed: May 29, 2024

(51) Int. Cl. G06F 21/62; G06F 21/60

(52) U.S. Cl. CPC G06F 21/6227; G06F 21/602

(57) ABSTRACT

Methods, systems, and non-transitory computer readable media are configured to perform operations comprising receiving an embedding vector associated with first data; permuting the embedding vector to generate a permuted embedding vector; and providing the permuted embedding vector to a vector database.

### FIELD OF THE INVENTION

The present technology relates to the field of generative artificial intelligence. More particularly, the present technology relates to techniques to protect against embedding inversion attacks in retrieval augmented generation.

### BACKGROUND

Embedding models can use machine learning techniques to convert content, such as text, audio, and image data, into embedding vectors that capture meaning and semantics from the content. Often, embedding vectors are representative of sensitive or private data. Embedding vectors can be stored in vector databases. Accordingly, the protection and security of the embedding vectors are important considerations in handling and management of embedding vectors and vector databases.

### SUMMARY

Various embodiments of the present technology can include systems, methods, and non-transitory computer readable media configured to perform operations comprising: receiving an embedding vector associated with first data; permuting the embedding vector to generate a permuted embedding vector; and providing the permuted embedding vector to a vector database.

In some embodiments, the permuted embedding vector is associated with content from a knowledge store, the operations further comprising: providing the permuted embedding vector to be maintained in the vector database.

In some embodiments, the permuted embedding vector is associated with a query, the operations further comprising: providing the permuted embedding vector for a search of the vector database.

In some embodiments, the operations further comprise: acquiring a seed of a plurality of seeds, each seed associated with a corresponding permutation, wherein embedding vectors associated with content from a knowledge store and an embedding vector associated with a query are permuted in the same manner based on the acquired seed.

In some embodiments, the operations further comprise: encrypting the acquired seed; and storing the encrypted acquired seed independently from the vector database.

In some embodiments, the acquired seed is randomly generated.

In some embodiments, the first data and second data are associated with at least one of different accounts, different domains, or different chatbots, and a permutation associated with a seed is applied to embedding vectors associated with the first data and the second data.

In some embodiments, the first data and second data are associated with at least one of different accounts, different domains, or different chatbots, a first permutation associated with a first seed is applied to embedding vectors associated with the first data, and a second permutation associated with a second seed is applied to embedding vectors associated with the second data.

In some embodiments, the first data is associated with at least one of textual information, visual information, or audio information.

In some embodiments, the operations further comprise: determining metadata associated with a resulting permuted embedding vector from the vector database that is responsive to a query; determining content associated with the resulting permuted embedding vector based on the metadata; and utilizing the content in a prompt for provision to a large language model.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates a system including a retrieval augmented generation (RAG) management system that enhances data security, according to an embodiment of the present technology.

FIG. 2 illustrates processing of embedding vectors, according to an embodiment of the present technology.

FIG. 3 illustrates permutation of an embedding vector, according to an embodiment of the present technology.

FIGS. 4A-4C illustrate associations between seeds and various data, according to an embodiment of the present technology.

FIG. 5 illustrates acquisition of contextual information for an enhanced prompt, according to an embodiment of the present technology.

FIG. 6 illustrates a method, according to an embodiment of the present technology.

FIG. 7 illustrates a method, according to an embodiment of the present technology.

FIG. 8 illustrates an environment associated with a data management service, according to an embodiment of the present technology.

FIG. 9 illustrates an example computer system, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Embedding models can use machine learning techniques to convert content, such as text, audio, and image data, into embedding vectors. Content with semantic similarity can be transformed into similar embedding vectors. Vector databases can store embedding vectors so that embedding vectors that are similar, or representative of semantically similar content, are located in proximity to each other in the related embedding space.

Retrieval augmented generation (RAG) methodologies can use vector databases and their stored embedding vectors. An embedding model can convert a query associated with a prompt into a query embedding vector. The query embedding vector can be used to search a vector database for similar embedding vectors. Relevant embedding vectors are identified from the search. From these embedding vectors, associated content can be identified and provided to a large language model (LLM) to assist in generation of a response to the prompt.

The utilization of embedding vectors and vector databases in conventional RAG methodologies can pose security risks. In an embedding inversion attack, a machine learning model can invert embedding vectors back into their associated content. In this regard, the machine learning model can approximate the embedding function and can then reconstruct original text, audio, or image data from an embedding vector. Accordingly, embedding inversion attacks pose a threat to entities storing embedding vectors associated with sensitive information in vector databases.

Different techniques have been attempted to prevent embedding inversion attacks. For example, one conventional technique encrypts embedding vectors. Encryption can occur in multiple layers, complicating the ability of embedding inversion attacks to reconstruct original content. An encryption key can be required to decrypt the embedding vectors. However, encryption of embedding vectors can degrade search performance. In addition, a machine learning model may still be able to reconstruct original content through training on a per-key based approach. As another example, a conventional technique to prevent embedding inversion attacks adds Gaussian noise to an embedding vector. While such measures may increase the difficulty of reconstructing content from embedding vectors, machine learning models can be trained to account for Gaussian noise. Thus, the threat from embedding inversion attacks persists.

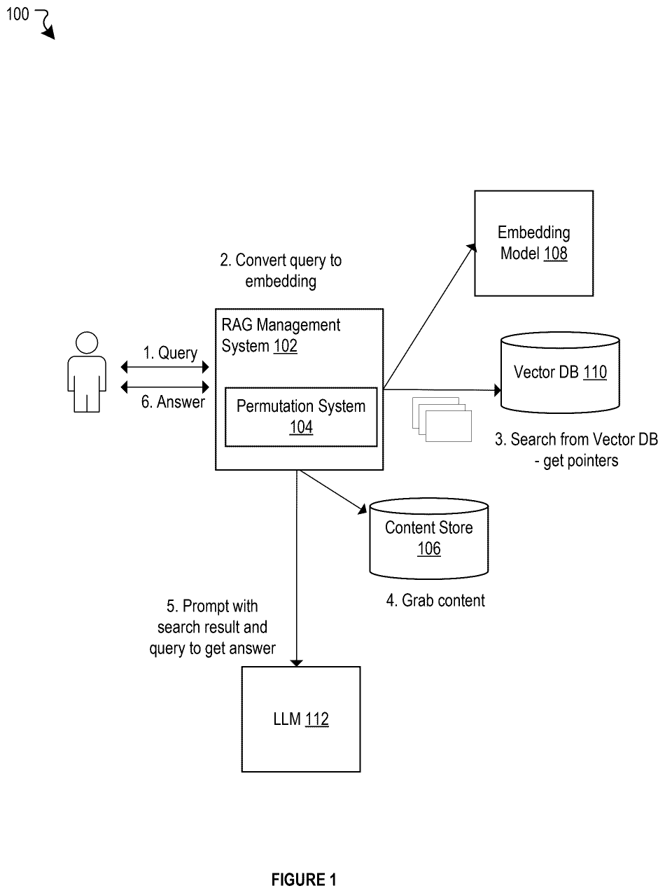

An improved approach rooted in computer technology overcomes the foregoing and other disadvantages associated with conventional approaches specifically arising in the realm of computer technology. FIG. 1 illustrates an example system 100 including a retrieval augmented generation (RAG) management system 102 that enhances data security in a RAG environment, according to an embodiment of the present technology. The RAG management system 102 can include a permutation system 104. The RAG management system 102 can be associated with a content store 106, an embedding model 108, a vector database 110, and a large language model (LLM) 112. The components and features (e.g., modules, elements, stores, functionalities, operations, etc.) shown in this figure and all figures herein are exemplary only, and other implementations may include additional, fewer, integrated, or different components. Some components or features may not be shown so as not to obscure relevant details. In various embodiments, one or more of the components and features described in connection with the system 100 or the RAG management system 102 can be implemented in any suitable combinations.

Content from the content store 106, which constitutes a knowledge base or repository, can be provided to the embedding model 108 to generate embedding vectors representative of the content (or content embedding vectors). The content can be any contextual or relevant information that when augmented with a prompt can optimize a response provided by the LLM 112. For example, the content can be a chunk of text, a document, a file, a record, an image, a video, etc. The embedding model 108 can be any suitable embedding model (e.g., text-embedding-ada-002 (or ada v2), text-embedding-3-small, etc.). As just one example, the embedding model 108 can generate embedding vectors having a dimension of 1536. In some embodiments, the content can be textual information. In some instances, the content can be multi-modal content including textual information, audio data, image data, video data, and the like, or any combination thereof. Accordingly, the embedding model 108 can generate embedding vectors that are suitably representative of the mode or type of content.

In contrast to conventional RAG techniques, the RAG management system 102 does not provide the content embedding vectors to the vector database 110. Rather, the permutation system 104 of the RAG management system 102 can apply one or more permutations to the content embedding vectors based on one or more seeds. As discussed in more detail herein, a seed associated with a corresponding search space or a related chatbot (or chatbot unique ID) provided by the RAG management system 102 can specify a particular permutation. The permutation specified by a seed can be applied in the same manner to content embedding vectors and query embedding vectors of the associated search space. In some instances, the permutation system 104 can apply a plurality of permutations to content embedding vectors and query embedding vectors based on a plurality of seeds associated with various search spaces.

The RAG management system 102 can cause permuted content embedding vectors to be stored in the vector database 110. The vector database 110 can be any suitable vector database (e.g., Pinecone, Azure AI Search, etc.). In some instances, the vector database 110 can be external to the RAG management system 102 or cloud environment in which the RAG management system 102 may reside. The permutation of content embedding vectors and storage of permuted content embedding vectors in the vector database 110 instead of content embedding vectors in this manner protect the security of associated content and optimize defense against embedding inversion attacks that attempt to illegitimately recover content from embedding vectors. The vector database 110 also can store pointers associated with the permuted content embedding vectors. A pointer can indicate a location in the content store 106 of content represented by a permuted content embedding vector as well as other metadata. To further enhance data security and privacy, a seed utilized for permutation of embedding vectors, as discussed in more detail herein, can be maintained in a repository that is separate and independent from the vector database 110. In some instances, the seed can be encrypted prior to storage.

The RAG management system 102 can facilitate automated communications with a user through the chatbot provided by the RAG management system 102. For example, the user can submit a prompt through a communication application provided by the RAG management system 102 to support operation of the chatbot. The RAG management system 102 can create a query based on the prompt. The RAG management system 102 can provide the query to the embedding model 108 to generate an embedding vector representative of the query (or query embedding vector). The permutation system 104 of the RAG management system 102 can access the seed associated with the relevant search space or chatbot, which is the same seed utilized to permute content embedding vectors for the search space. If the seed has been encrypted, the seed can be decrypted. The RAG management system 102 can permute the query embedding vector based on the seed to generate a permuted query embedding vector. The permuted query embedding vector can be provided to the vector database 110 to perform a search. The use of the same seed to permute in the same manner the query embedding vector and the content embedding vectors relating to the same search space can preserve effective searching in the search space. That is, when the same seed is used for permutation, the relative distance in an embedding space among given embedding vectors is preserved in a permuted embedding space of permuted embedding vectors generated from the given embedding vectors. The search of the vector database 110 can result in identification of permuted content embedding vectors stored in the vector database 110 that are most related or similar to the permuted query embedding vector.

Based on pointers associated with the resulting permuted content embedding vectors, the RAG management system 102 can access the associated content from the content store 106. The content can be included in an enhanced (or augmented) prompt as contextual or relevant information associated with the original prompt. The enhanced prompt can be provided to the LLM 112 to elicit a response. The RAG management system 102 through the communication application can provide the response to the user. More details regarding the RAG management system 102 and the permutation system 104 are provided herein.

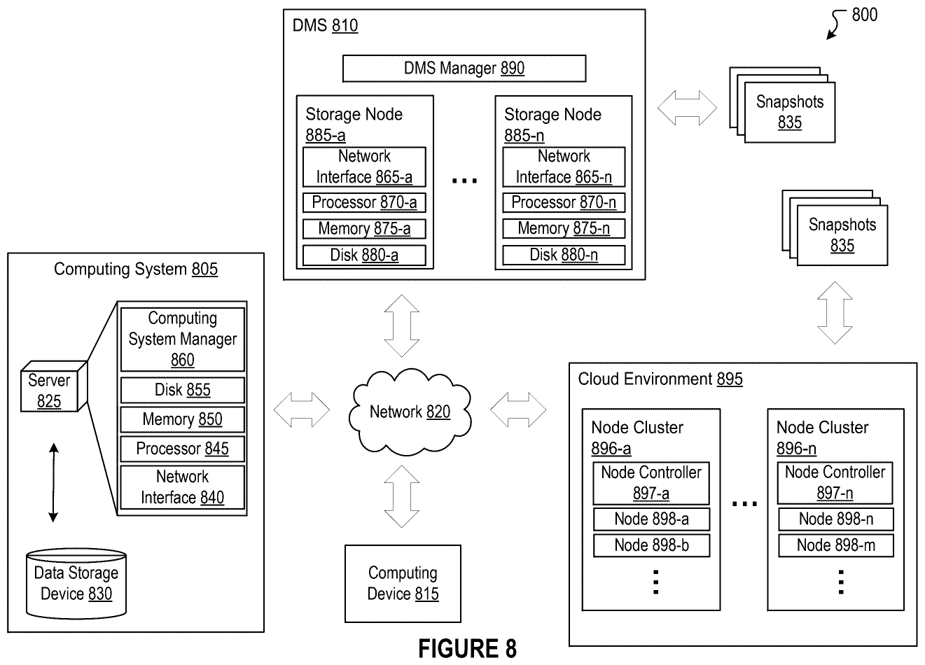

In some embodiments, the RAG management system 102 can be implemented by or in a data management service (DMS) 810 as described in connection with FIG. 8. For example, the data management service 810 can provide a data backup service, a data recovery service, a data classification service, a data transfer or replication service, and the like for its users (e.g., customers). In addition, the data management service 810 can provide an artificial intelligence (AI) assisted generative data service, such as provision of chatbot services, for its users. Data managed by the data management service 810, such as backup data, can be utilized as content or a knowledge base for the RAG management system 102 in the provision of the chatbot services.

The system 100 can include many variations. In some instances, one entity (e.g., organization) can control, operate, maintain, or provide the RAG management system 102 and the content store 106, while one or more other entities (e.g., third parties) can control, operate, maintain, or provide the embedding model 108, the vector database 110, and the LLM 112. For example, the entity that controls, operates, maintains, or provides the RAG management system 102 can utilize the embedding model 108, the vector database 110, and the LLM 112 as external services remotely hosted by other entities. In some instances, an entity can control, operate, maintain, or provide the RAG management system 102 and the content store 106, as well as one or a combination of the embedding model 108, the vector database 110, and the LLM 112. For example, the entity that controls, operates, maintains, or provides the RAG management system 102 can implement on-premises one or more of the embedding model 108, the vector database 110, and the LLM 112. Many variations are possible.

In some embodiments, the RAG management system 102 can be implemented by a server system or in the cloud. In some embodiments, some of the functionality of the RAG management system 102 can be performed by an application associated with the RAG management system 102 and run on a client computing device. In some embodiments, the functionality of the RAG management system 102 can be distributed between a server system and an application running on a client computing device.

Although the present technology is sometimes herein described in relation to a RAG environment, the present technology in some embodiments can be implemented in a variety of different environments and contexts apart from RAG. For example, the present technology can apply to any implementation involving the generation, storage, or communication of embedding vectors representative of sensitive or protected data.

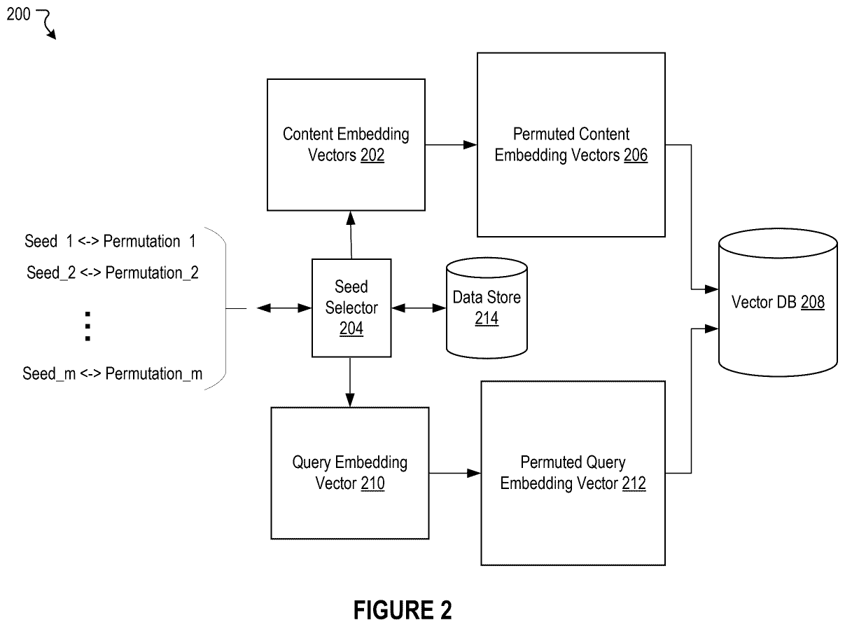

FIG. 2 illustrates a block diagram 200 of processing of embedding vectors, according to an embodiment of the present technology. In some embodiments, functionality of the block diagram 200 can be performed by the RAG management system 102 and the permutation system 104. Content from a content store (e.g., the content store 106) can be provided to an embedding model (e.g., the embedding model 108) to generate content embedding vectors 202. The content can be associated with a search space or related chatbot (or chatbot unique ID). The content can be used as contextual information in an enhanced prompt to elicit optimal responses from an LLM (e.g., the LLM 112) in a communication session between a user and the chatbot.

A seed selector 204 can select a seed associated with the search space. In some instances, the seed selector 204 can implement a random or pseudo random number generator. A seed (or seed value) can function as an initial input into the number generator to create a sequence of random numbers. After a seed is set, the same sequence of numbers is generated for the seed. That is, given the same seed, the same sequence is generated in a deterministic manner. A seed can specify a particular permutation based on the sequence of numbers corresponding to the seed. Thus, for the same seed, permutation of content embedding vectors and query embedding vectors based on the seed will occur in the same manner. In some instances, a permutation can be determined for a seed in other suitable manners. The seed selector 204 can access a data store 214 to determine a seed associated with the relevant search space or related chatbot (or chatbot unique ID) for content embedding vectors. If no seed is already determined for the search space, a seed can be randomly selected. The seed and its association with the corresponding search space and related chatbot unique ID can be maintained in the data store 214. The data store 214 can be controlled by the entity in control of the RAG management system 102. In some instances, the data store 214 can be separated, isolated, or independent from a vector database 208 that stores permuted content embedding vectors 206. In some embodiments, the vector database 208 can be the vector database 110. In some instances, a suitable encryption technique can be performed to encrypt the seed. The encrypted seed can be stored in the data store 214. In some instances, a key used to encrypt a seed can be periodically (e.g., at regular intervals) changed to optimize security of the key.

The seed determined by the seed selector 204 can be utilized to apply an associated permutation to the content embedding vectors 202. The permutation of the content embedding vectors 202 can generate the permuted content embedding vectors 206. The permuted content embedding vectors 206, not the content embedding vectors 202, can be provided for storage in the vector database 208. Pointers and related chatbot IDs associated with the permuted content embedding vectors 206 also can be provided for storage in the vector database 208. A pointer corresponding to a permuted content embedding vector can indicate a location in the content store of content represented by the permuted content embedding vector as well as other related metadata (e.g., content identifier, time stamp, offset, length, etc.). For example, the pointer can be associated with a hash of the content represented by the permuted content embedding vector. Through a pointer corresponding to a permuted content embedding vector, associated content can be retrieved to provide contextual or relevant information to complement a prompt provided by a user, as discussed in more detail herein.

During a communication session, a user can provide a prompt to the chatbot. A query can be generated from the prompt. The query can be provided to the embedding model to generate a query embedding vector 210. Based on the chatbot, the seed selector 204 can select the seed associated with the chatbot or related search space. The permutation specified by the seed can be used to permute the query embedding vector 210 to generate a permuted query embedding vector 212. The use of the same seed for generating the permuted content embedding vectors 206 and the permuted query embedding vector 212 transforms the embedding vectors so that their relative distance to one another in the embedding space is preserved in the permuted embedding space. In this way, an effective search of the permuted embedding space can be performed. The permuted query embedding vector 212 can be provided to the vector database 208 to perform a search for similar or matching permuted content embedding vectors 206.

The permuted content embedding vectors 202 and the permuted query embedding vector 212 preserve effective searching in the search space. In addition, they significantly enhance security against embedding inversion attacks. The security enhancement is associated with a factorial increase in the complexity of an attack. For an embedding vector of dimension n, there are n! (factorial of n) possible ways to permute its dimensions. Without knowledge of the specific permutation applied, an attack will face the prohibitive challenge of correctly rearranging the dimensions to recover accurate and meaningful original data. For instance, if the number of dimensions in an embedding vector is 1,563, the number of possible permutations of 1,563 dimensions is 1,563 factorial (1,563!). This magnitude of factorial complexity can render various types of attacks (e.g., brute-force attacks, sophisticated guessing strategies, etc.) infeasible. Moreover, even if an attack can partially reconstruct some data associated with a permuted embedding vector, the lack of correct dimensional alignment due to an unknown permutation significantly limits the usefulness or correctness of such reconstructed data. Thus, the present technology provides a robust solution to protect the data transformed into embedding vectors, enhancing privacy and security in systems relying on vector databases for storing and processing the embedding vectors.

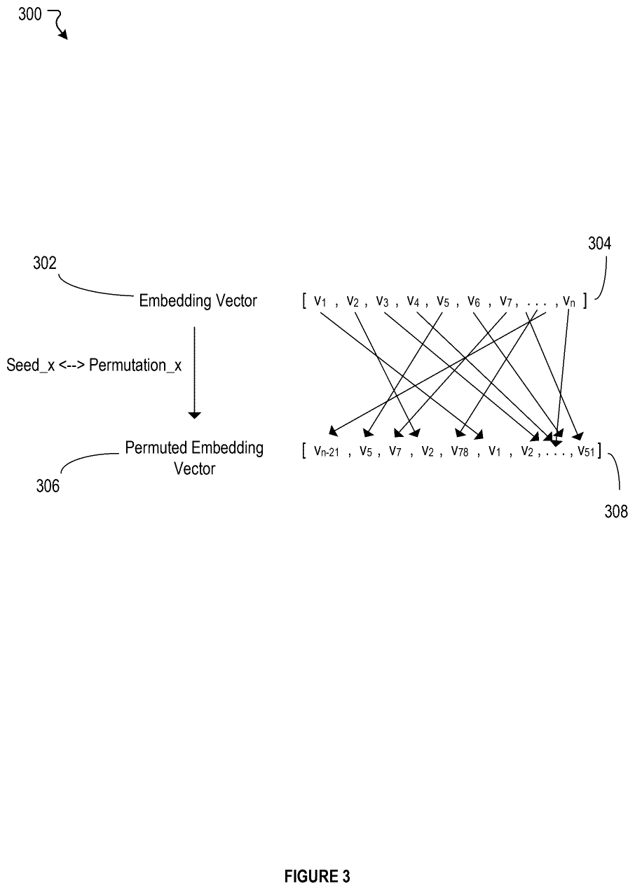

FIG. 3 illustrates permutation of an embedding vector, according to an embodiment of the present technology. In some embodiments, permutation of the embedding vector can be performed by the RAG management system 102 and the permutation system 104. An embedding vector 302 is represented as an array 304 having n dimensions. The embedding vector 302 can be representative of content or can be representative of a query. Each value in the array 304 can represent a dimension in an associated embedding space. The number of values in the array 304 can be any suitable number. In some instances, the number of values in the array 304 can be determined by an embedding model utilized to generate the embedding vector 302. For example, the number of values in the array 304 can be 1536 in one implementation.

A particular seed can be selected to permute the embedding vector 302. The seed can specify a particular permutation to be applied to the embedding vector 302. Permutation of the embedding vector 302 can permute, or shuffle, the order of the values in the array 304 to generate a permuted embedding vector 306 represented as an array 308. For example, as illustrated, the first value (v₁) in the array 304 is shuffled to be the sixth value in the array 308. As another example, the second value (v₂) in the array 304 is shuffled to be the fourth value in the array 308. As yet another example, the n−21 value (Vₙ₋₂₁) is shuffled to be the first value in the array 308. Every embedding vector permuted based on the same seed will be shuffled in the same manner in a deterministic manner. The number of dimensions of the permuted embedding vector 306 is the same as the number of dimensions of the embedding vector 302.

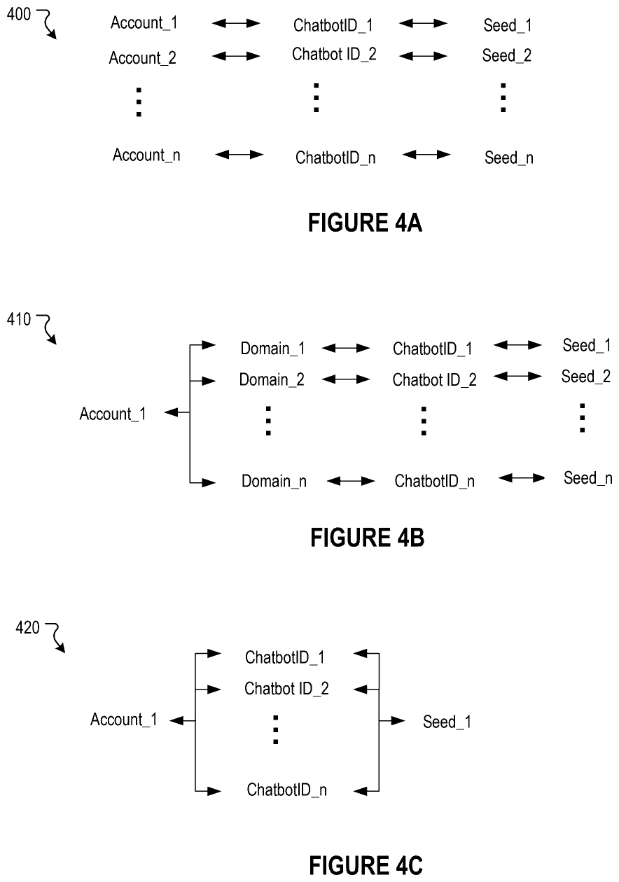

FIGS. 4A-4C are illustrations of associations between seeds and various data, according to an embodiment of the present technology. In some embodiments, the associations between seeds and various data can be determined by the RAG management system 102 and the permutation system 104. The permutation system 104 can determine a search space (or a collection). The search space can be associated with a set of content in a content store (or knowledge base) against which a search is to be performed. In some instances, the set of content can be the entirety of the content store. In some instances, the set of content can be portions or segments of the content store. The permutation system 104 can assign a seed to a search space. The permutation system 104 can determine a search space in various manners.

In some instances, when a content store accessible to the RAG management system 102 contains data associated with multiple accounts (or customers), a search space can be determined for data associated with each account. A different chatbot can be used for each account. A different seed can be associated with each account (or account unique ID) and its corresponding chatbot (or chatbot unique ID). In this manner, data associated with one account can remain inaccessible to searches against data associated with another account. As shown in illustration 400 of FIG. 4A, a different seed is associated with each account and its corresponding chatbot. Thus, the RAG management system 102 and the permutation system 104 can determine that embedding vectors representative of data associated with a first account corresponding to a first chatbot are to be permuted based on a first seed; embedding vectors representative of data associated with a second account corresponding to a second chatbot are to be permuted based on a second seed; and so on.

In some instances, when a content store accessible to the RAG management system 102 contains data associated with multiple domains of an account, a search space can be determined for data associated with each domain. A domain can be a category or type of data associated with an account. As just one example, if the account relates to a company, a first domain can be data associated with offerings of the company, a second domain can be data associated with employees of the company, a third domain can be data associated with finances of the company, etc. A different chatbot can be used for each domain. A different seed can be associated with each domain (or domain unique ID) and its corresponding chatbot (or chatbot unique ID). As shown in illustration 410 of FIG. 4B, a different seed is associated with each domain of an account and a chatbot corresponding to the domain. Thus, the RAG management system 102 and the permutation system 104 can determine that, for an account, embedding vectors representative of data associated with a first domain corresponding to a first chatbot are to be permuted based on a first seed; embedding vectors representative of data associated with a second domain corresponding to a second chatbot are to be permuted based on a second seed; and so on.

In some instances, when a content store accessible to the RAG management system 102 contains data associated with an account, a search space can be determined for the data associated with the account. Multiple chatbots can be used for the account. A seed can be associated with the account (or account unique ID) and its corresponding chatbots (or chatbot unique IDs). As shown in illustration 420 of FIG. 4C, a seed is associated with an account and its multiple chatbots. Thus, the RAG management system 102 and the permutation system 104 can determine that embedding vectors representative of data associated with an account associated with multiple chatbots are to be permuted based on one seed. Many variations and combinations are possible.

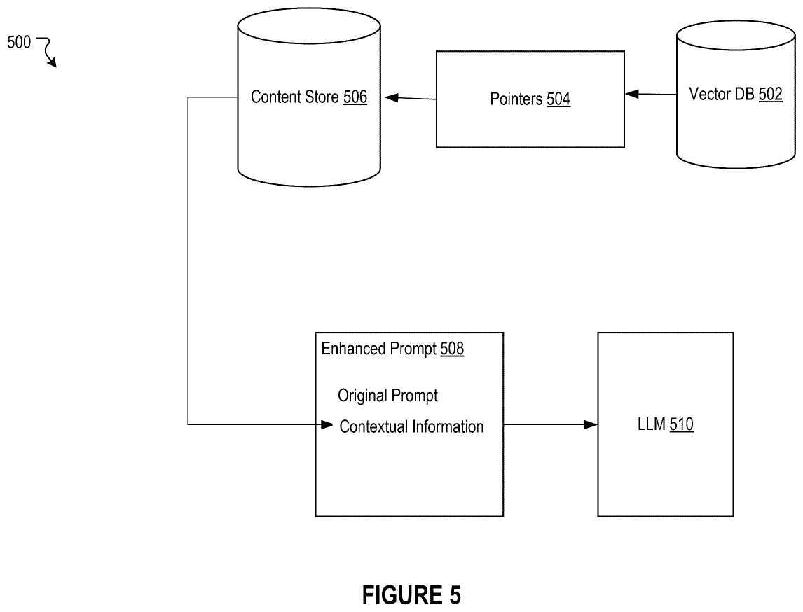

FIG. 5 illustrates a block diagram 500 of acquisition of contextual information for an enhanced prompt, according to an embodiment of the present technology. In some embodiments, functionality of the block diagram 500 can be performed by the RAG management system 102 and the permutation system 104. A vector database 502 can contain permuted content embedding vectors. In some embodiments, the vector database 502 can be the vector database 110. A permuted query embedding vector can be provided to the vector database 502 to perform a search. In some embodiments, the LLM 510 can be the LLM 112. As discussed, the permuted content embedding vectors and the permuted query embedding vector can be generated through permutation of corresponding embedding vectors based on the same seed associated with the chatbot.

A variety of search techniques can be performed to find resulting matches with the permuted query embedding vector in the permuted embedding space. For example, searching in the permuted embedding space can be based on cosine similarity, nearest neighbor search, dot product, locality-sensitive hashing, and the like. The search can result in identification of permuted content embedding vectors that are closest to the permuted query embedding vector in the permuted embedding space. The resulting permuted content embedding vectors can be representative of content that can provide contextual or relevant information for an enhanced prompt 508 to be provided to an LLM 510 during communications with a chatbot. Pointers 504 associated with the resulting permuted content embedding vectors can be retrieved from the vector database 502. Based on the pointers 504, the associated content can be located in a content store 506. In some embodiments, the content store 506 can be the content store 106. Once located in the content store 506, the content can be copied or otherwise extracted and inserted into the enhanced prompt 508 as contextual or relevant information. The enhanced prompt 508 can include various information, such as an original prompt provided by a user as well as the contextual or relevant information. The enhanced prompt 508 can elicit an optimal response from the LLM 510.

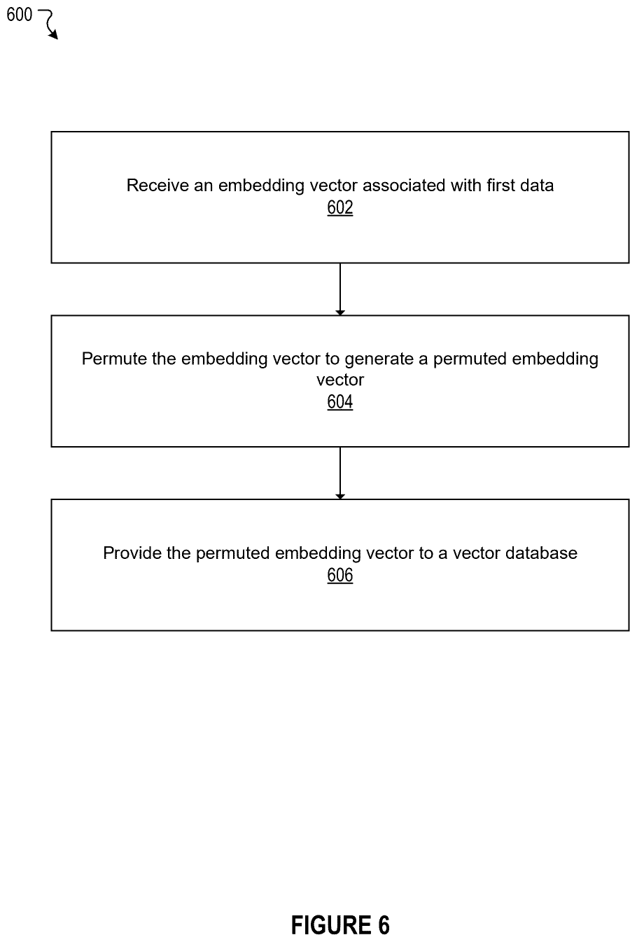

FIG. 6 illustrates an example method 600, according to an embodiment of the present technology. It should be understood that there can be additional, fewer, or alternative steps performed in similar or alternative orders, or in parallel, based on the various features and embodiments discussed herein unless otherwise stated. At block 602, the method 600 can receive an embedding vector associated with first data. At block 604, the method 600 can permute the embedding vector to generate a permuted embedding vector. At block 606, the method 600 can provide the permuted embedding vector to a vector database.

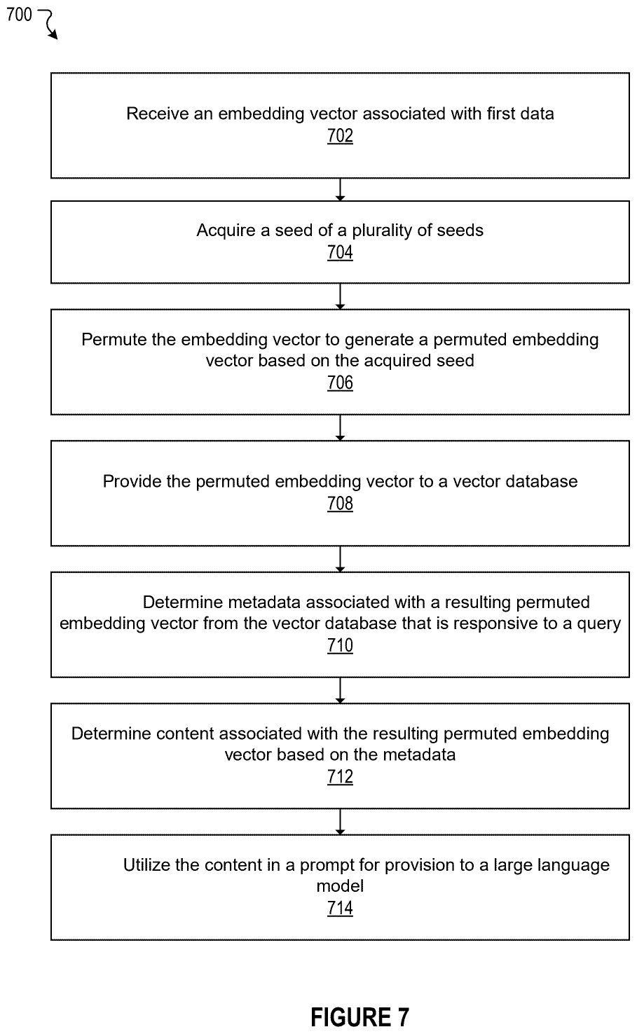

FIG. 7 illustrates an example method 700, according to an embodiment of the present technology. It should be understood that there can be additional, fewer, or alternative steps performed in similar or alternative orders, or in parallel, based on the various features and embodiments discussed herein unless otherwise stated. At block 702, the method 700 can receive an embedding vector associated with first data. At block 704, the method 700 can acquire a seed of a plurality of seeds. At block 706, the method 700 can permute the embedding vector to generate a permuted embedding vector based on the acquired seed. At block 708, the method 700 can provide the permuted embedding vector to a vector database. At block 710, the method 700 can determine metadata associated with a resulting permuted embedding vector from the vector database that is responsive to a query. At block 712, the method 700 can determine content associated with the resulting permuted embedding vector based on the metadata. At block 714, the method 700 can utilize the content in a prompt for provision to a large language model.

FIG. 8 illustrates an example of a computing environment 800 in which the RAG management system 102 can be implemented in accordance with the present technology. The computing environment 800 may include a computing system 805, a data management service (DMS) 810, and one or more computing devices 815, which may be in communication with one another via a network 820. The computing system 805 may generate, store, process, modify, or otherwise use associated data, and the DMS 810 may provide one or more data management services for the computing system 805. For example, the DMS 810 may provide a data backup service, a data recovery service, a data classification service, a data transfer or replication service, a malware protection service, a sensitive data classification service, and an artificial intelligence (AI) assisted generative data service. For example, the AI assisted generative data service can support chatbot services empowering users of the DMS 810 to ask questions, troubleshoot problems, or initiate workflows.

The network 820 may allow the one or more computing devices 815, the computing system 805, and the DMS 810 to communicate (e.g., exchange information) with one another. The network 820 may include aspects of one or more wired networks (e.g., the Internet), one or more wireless networks (e.g., cellular networks), or any combination thereof. The network 820 may include aspects of one or more public networks or private networks, as well as secured or unsecured networks, or any combination thereof. The network 820 also may include any quantity of communications links and any quantity of hubs, bridges, routers, switches, ports or other physical or logical network components.

A computing device 815 may be used to input information to or receive information from the computing system 805, the DMS 810, or both. For example, a user of the computing device 815 may provide user inputs via the computing device 815, which may result in commands, data, or any combination thereof being communicated via the network 820 to the computing system 805, the DMS 810, or both. Additionally, or alternatively, a computing device 815 may output (e.g., display) data or other information received from the computing system 805, the DMS 810, or both. A user of a computing device 815 may, for example, use the computing device 815 to interact with one or more UIs (e.g., graphical user interfaces (GUIs)) to operate or otherwise interact with the computing system 805, the DMS 810, or both. Though one computing device 815 is shown in FIG. 8, it is to be understood that the computing environment 800 may include any quantity of computing devices 815.

A computing device 815 may be a stationary device (e.g., a desktop computer or access point) or a mobile device (e.g., a laptop computer, tablet computer, or cellular phone). In some examples, a computing device 815 may be a commercial computing device, such as a server or collection of servers. And in some examples, a computing device 815 may be a virtual device (e.g., a virtual machine). Though shown as a separate device in the example computing environment of FIG. 8, it is to be understood that in some cases a computing device 815 may be included in (e.g., may be a component of) the computing system 805 or the DMS 810.

The computing system 805 may include one or more servers 825 and may provide (e.g., to the one or more computing devices 815) local or remote access to applications, databases, or files stored within the computing system 805. The computing system 805 may further include one or more data storage devices 830. Though one server 825 and one data storage device 830 are shown in FIG. 8, it is to be understood that the computing system 805 may include any quantity of servers 825 and any quantity of data storage devices 830, which may be in communication with one another and collectively perform one or more functions ascribed herein to the server 825 and data storage device 830.

A data storage device 830 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 830 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 830 may be a database (e.g., a relational database), and a server 825 may host (e.g., provide a database management system for) the database.

A server 825 may allow a client (e.g., a computing device 815) to download information or files (e.g., executable, text, application, audio, image, or video files) from the computing system 805, to upload such information or files to the computing system 805, or to perform a search related to particular information stored by the computing system 805. In some examples, a server 825 may act as an application server or a file server. In general, a server 825 may refer to one or more hardware devices that act as the host in a client-server relationship or a software process that shares a resource with or performs work for one or more clients.

A server 825 may include a network interface 840, processor 845, memory 850, disk 855, and computing system manager 860. The network interface 840 may enable the server 825 to connect to and exchange information via the network 820 (e.g., using one or more network protocols). The network interface 840 may include one or more wireless network interfaces, one or more wired network interfaces, or any combination thereof. The processor 845 may execute computer-readable instructions stored in the memory 850 in order to cause the server 825 to perform functions ascribed herein to the server 825. The processor 845 may include one or more processing units, such as one or more central processing units (CPUs), one or more graphics processing units (GPUs), or any combination thereof. The memory 850 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 855 may include one or more HDDs, one or more SSDs, or any combination thereof. Memory 850 and disk 855 may comprise hardware storage devices. The computing system manager 860 may manage the computing system 805 or aspects thereof (e.g., based on instructions stored in the memory 850 and executed by the processor 845) to perform functions ascribed herein to the computing system 805. In some examples, the network interface 840, processor 845, memory 850, and disk 855 may be included in a hardware layer of a server 825, and the computing system manager 860 may be included in a software layer of the server 825. In some cases, the computing system manager 860 may be distributed across (e.g., implemented by) multiple servers 825 within the computing system 805.

In some examples, the computing system 805 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 805 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 815 over the network 820). IaaS may refer to a service in which physical computing resources are used to instantiate one or more virtual machines, the resources of which are made available to one or more client devices over a network (e.g., to one or more computing devices 815 over the network 820).

In some examples, the computing system 805 or aspects thereof may implement or be implemented by one or more virtual machines. The one or more virtual machines may run various applications, such as a database server, an application server, or a web server. For example, a server 825 may be used to host (e.g., create, manage) one or more virtual machines, and the computing system manager 860 may manage a virtualized infrastructure within the computing system 805 and perform management operations associated with the virtualized infrastructure. The computing system manager 860 may manage the provisioning of virtual machines running within the virtualized infrastructure and provide an interface to a computing device 815 interacting with the virtualized infrastructure. For example, the computing system manager 860 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 855, the memory, the processor 845, the network interface 840, the data storage device 830, or any combination thereof in support of running the various applications. Storage resources (e.g., the disk 855, the memory 850, or the data storage device 830) that are virtualized may be accessed by applications as a virtual disk.

The DMS 810 may provide one or more data management services for data associated with the computing system 805 and may include DMS manager 890 and any quantity of storage nodes 885. The DMS manager 890 may manage operation of the DMS 810, including the storage nodes 885. Though illustrated as a separate entity within the DMS 810, the DMS manager 890 may in some cases be implemented (e.g., as a software application) by one or more of the storage nodes 885. In some examples, the storage nodes 885 may be included in a hardware layer of the DMS 810, and the DMS manager 890 may be included in a software layer of the DMS 810. In the example illustrated in FIG. 8, the DMS 810 is separate from the computing system 805 but in communication with the computing system 805 via the network 820. It is to be understood, however, that in some examples at least some aspects of the DMS 810 may be located within computing system 805. For example, one or more servers 825, one or more data storage devices 830, and at least some aspects of the DMS 810 may be implemented within the same cloud environment or within the same data center.

Storage nodes 885 of the DMS 810 may include respective network interfaces 865, processors 870, memories 875, and disks 880. The network interfaces 865 may enable the storage nodes 885 to connect to one another, to the network 820, or both. A network interface 865 may include one or more wireless network interfaces, one or more wired network interfaces, or any combination thereof. The processor 870 of a storage node 885 may execute computer-readable instructions stored in the memory 875 of the storage node 885 in order to cause the storage node 885 to perform processes described herein as performed by the storage node 885. A processor 870 may include one or more processing units, such as one or more CPUs, one or more GPUs, or any combination thereof. The memory 875 may comprise one or more types of memory (e.g., RAM, SRAM, DRAM, ROM, EEPROM, Flash, etc.). A disk 880 may include one or more HDDs, one or more SDDs, or any combination thereof. Memories 875 and disks 880 may comprise hardware storage devices. Collectively, the storage nodes 885 may in some cases be referred to as a storage cluster or as a cluster of storage nodes 885.

The DMS 810 may provide a backup and recovery service for the computing system 805. For example, the DMS 810 may manage the extraction and storage of snapshots 835 associated with different point-in-time versions of one or more target computing objects within the computing system 805. A snapshot 835 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 835 may also be used to restore (e.g., recover) the corresponding computing object as of the particular point in time corresponding to the snapshot 835. A computing object of which a snapshot 835 may be generated may be referred to as snappable. Snapshots 835 may be generated at different times (e.g., periodically or on some other scheduled or configured basis) in order to represent the state of the computing system 805 or aspects thereof as of those different times. In some examples, a snapshot 835 may include metadata that defines a state of the computing object as of a particular point in time. For example, a snapshot 835 may include metadata associated with (e.g., that defines a state of) some or all data blocks included in (e.g., stored by or otherwise included in) the computing object. Snapshots 835 (e.g., collectively) may capture changes in the data blocks over time. Snapshots 835 generated for the target computing objects within the computing system 805 may be stored in one or more storage locations (e.g., the disk 855, memory 850, the data storage device 830) of the computing system 805, in the alternative or in addition to being stored within the DMS 810, as described below.

To obtain a snapshot 835 of a target computing object associated with the computing system 805 (e.g., of the entirety of the computing system 805 or some portion thereof, such as one or more databases, virtual machines, or filesystems within the computing system 805), the DMS manager 890 may transmit a snapshot request to the computing system manager 860. In response to the snapshot request, the computing system manager 860 may set the target computing object into a frozen state (e.g., a read-only state). Setting the target computing object into a frozen state may allow a point-in-time snapshot 835 of the target computing object to be stored or transferred.

In some examples, the computing system 805 may generate the snapshot 835 based on the frozen state of the computing object. For example, the computing system 805 may execute an agent of the DMS 810 (e.g., the agent may be software installed at and executed by one or more servers 825), and the agent may cause the computing system 805 to generate the snapshot 835 and transfer the snapshot 835 to the DMS 810 in response to the request from the DMS 810. In some examples, the computing system manager 860 may cause the computing system 805 to transfer, to the DMS 810, data that represents the frozen state of the target computing object, and the DMS 810 may generate a snapshot 835 of the target computing object based on the corresponding data received from the computing system 805.

Once the DMS 810 receives, generates, or otherwise obtains a snapshot 835, the DMS 810 may store the snapshot 835 at one or more of the storage nodes 885. The DMS 810 may store a snapshot 835 at multiple storage nodes 885, for example, for improved reliability. Additionally, or alternatively, snapshots 835 may be stored in some other location connected with the network 820. For example, the DMS 810 may store more recent snapshots 835 at the storage nodes 885, and the DMS 810 may transfer less recent snapshots 835 via the network 820 to a cloud environment (which may include or be separate from the computing system 805) for storage at the cloud environment, a magnetic tape storage device, or another storage system separate from the DMS 810.

Updates made to a target computing object that has been set into a frozen state may be written by the computing system 805 to a separate file (e.g., an update file) or other entity within the computing system 805 while the target computing object is in the frozen state. After the snapshot 835 (or associated data) of the target computing object has been transferred to the DMS 810, the computing system manager 860 may release the target computing object from the frozen state, and any corresponding updates written to the separate file or other entity may be merged into the target computing object.

In response to a restore command (e.g., from a computing device 815 or the computing system 805), the DMS 810 may restore a target version (e.g., corresponding to a particular point in time) of a computing object based on a corresponding snapshot 835 of the computing object. In some examples, the corresponding snapshot 835 may be used to restore the target version based on data of the computing object as stored at the computing system 805 (e.g., based on information included in the corresponding snapshot 835 and other information stored at the computing system 805, the computing object may be restored to its state as of the particular point in time). Additionally, or alternatively, the corresponding snapshot 835 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 835. For example, the target version of the computing object may be restored based on the information in a snapshot 835 and based on information included in a backup copy of the target object generated prior to the time corresponding to the target version. Backup copies of the computing object may be stored at the DMS 810 (e.g., in the storage nodes 885) or in some other location connected with the network 820 (e.g., in a cloud environment, which in some cases may be separate from the computing system 805).

In some examples, the DMS 810 may restore the target version of the computing object and transfer the data of the restored computing object to the computing system 805. And in some examples, the DMS 810 may transfer one or more snapshots 835 to the computing system 805, and restoration of the target version of the computing object may occur at the computing system 805 (e.g., as managed by an agent of the DMS 810, where the agent may be installed and operate at the computing system 805).

In response to a mount command (e.g., from a computing device 815 or the computing system 805), the DMS 810 may instantiate data associated with a point-in-time version of a computing object based on a snapshot 835 corresponding to the computing object (e.g., along with data included in a backup copy of the computing object) and the point-in-time. The DMS 810 may then allow the computing system 805 to read or modify the instantiated data (e.g., without transferring the instantiated data to the computing system). In some examples, the DMS 810 may instantiate (e.g., virtually mount) some or all of the data associated with the point-in-time version of the computing object for access by the computing system 805, the DMS 810, or the computing device 815.

In some examples, the DMS 810 may store different types of snapshots 835, including for the same computing object. For example, the DMS 810 may store both base snapshots 835 and incremental snapshots 835. A base snapshot 835 may represent the entirety of the state of the corresponding computing object as of a point in time corresponding to the base snapshot 835. An incremental snapshot 835 may represent the changes to the state-which may be referred to as the delta-of the corresponding computing object that have occurred between an earlier or later point in time corresponding to another snapshot 835 (e.g., another base snapshot 835 or incremental snapshot 835) of the computing object and the incremental snapshot 835. In some cases, some incremental snapshots 835 may be forward-incremental snapshots 835 and other incremental snapshots 835 may be reverse-incremental snapshots 835. To generate a full snapshot 835 of a computing object using a forward-incremental snapshot 835, the information of the forward-incremental snapshot 835 may be combined with (e.g., applied to) the information of an earlier base snapshot 835 of the computing object along with the information of any intervening forward-incremental snapshots 835, where the earlier base snapshot 835 may include a base snapshot 835 and one or more reverse-incremental or forward-incremental snapshots 835. To generate a full snapshot 835 of a computing object using a reverse-incremental snapshot 835, the information of the reverse-incremental snapshot 835 may be combined with (e.g., applied to) the information of a later base snapshot 835 of the computing object along with the information of any intervening reverse-incremental snapshots 835.

In some examples, the DMS 810 may provide a data classification service, a malware detection service, a data transfer or replication service, backup verification service, or any combination thereof, among other possible data management services for data associated with the computing system 805. For example, the DMS 810 may analyze data included in one or more computing objects of the computing system 805, metadata for one or more computing objects of the computing system 805, or any combination thereof, and based on such analysis, the DMS 810 may identify locations within the computing system 805 that include data of one or more target data types (e.g., sensitive data, such as data subject to privacy regulations or otherwise of particular interest) and output related information (e.g., for display to a user via a computing device 815). Additionally, or alternatively, the DMS 810 may detect whether aspects of the computing system 805 have been impacted by malware (e.g., ransomware). Additionally, or alternatively, the DMS 810 may relocate data or create copies of data based on using one or more snapshots 835 to restore the associated computing object within its original location or at a new location (e.g., a new location within a different computing system 805). Additionally, or alternatively, the DMS 810 may analyze backup data to ensure that the underlying data (e.g., user data or metadata) has not been corrupted. The DMS 810 may perform such data classification, malware detection, data transfer or replication, or backup verification, for example, based on data included in snapshots 835 or backup copies of the computing system 805, rather than live contents of the computing system 805, which may beneficially avoid adversely affecting (e.g., infecting, loading, etc.) the computing system 805.

In some examples, the DMS 810, and in particular the DMS manager 890, may be referred to as a control plane. The control plane may manage tasks, such as storing data management data or performing restorations, among other possible examples. The control plane may be common to multiple customers or tenants of the DMS 810. For example, the computing system 805 may be associated with a first customer or tenant of the DMS 810, and the DMS 810 may similarly provide data management services for one or more other computing systems associated with one or more additional customers or tenants. In some examples, the control plane may be configured to manage the transfer of data management data (e.g., snapshots 835 associated with the computing system 805) to a cloud environment 895 (e.g., Microsoft Azure or Amazon Web Services). In addition, or as an alternative, to being configured to manage the transfer of data management data to the cloud environment 895, the control plane may be configured to transfer metadata for the data management data to the cloud environment 895. The metadata may be configured to facilitate storage of the stored data management data, the management of the stored management data, the processing of the stored management data, the restoration of the stored data management data, and the like.

Each customer or tenant of the DMS 810 may have a private data plane, where a data plane may include a location at which customer or tenant data is stored. For example, each private data plane for each customer or tenant may include a node cluster 896 across which data (e.g., data management data, metadata for data management data, etc.) for a customer or tenant is stored. Each node cluster 896 may include a node controller 897 which manages the nodes 898 of the node cluster 896. As an example, a node cluster 896 for one tenant or customer may be hosted on Microsoft Azure, and another node cluster 896 may be hosted on Amazon Web Services. In another example, multiple separate node clusters 896 for multiple different customers or tenants may be hosted on Microsoft Azure. Separating each customer or tenant's data into separate node clusters 896 provides fault isolation for the different customers or tenants and provides security by limiting access to data for each customer or tenant.

The control plane (e.g., the DMS 810, and specifically the DMS manager 890) manages tasks, such as storing backups or snapshots 835 or performing restorations, across the multiple node clusters 896. For example, as described herein, a node cluster 896-a may be associated with the first customer or tenant associated with the computing system 805. The DMS 810 may obtain (e.g., generate or receive) and transfer the snapshots 835 associated with the computing system 805 to the node cluster 896 a in accordance with a service level agreement for the first customer or tenant associated with the computing system 805. For example, a service level agreement may define backup and recovery parameters for a customer or tenant such as snapshot generation frequency, which computing objects to backup, where to store the snapshots 835 (e.g., which private data plane), and how long to retain snapshots 835. As described herein, the control plane may provide data management services for another computing system associated with another customer or tenant. For example, the control plane may generate and transfer snapshots 835 for another computing system associated with another customer or tenant to the node cluster 896 n in accordance with the service level agreement for the other customer or tenant.

To manage tasks, such as storing backups or snapshots 835 or performing restorations, across the multiple node clusters 896, the control plane (e.g., the DMS manager 890) may communicate with the node controllers 897 for the various node clusters via the network 820. For example, the control plane may exchange communications for backup and recovery tasks with the node controllers 897 in the form of transmission control protocol (TCP) packets via the network 820.

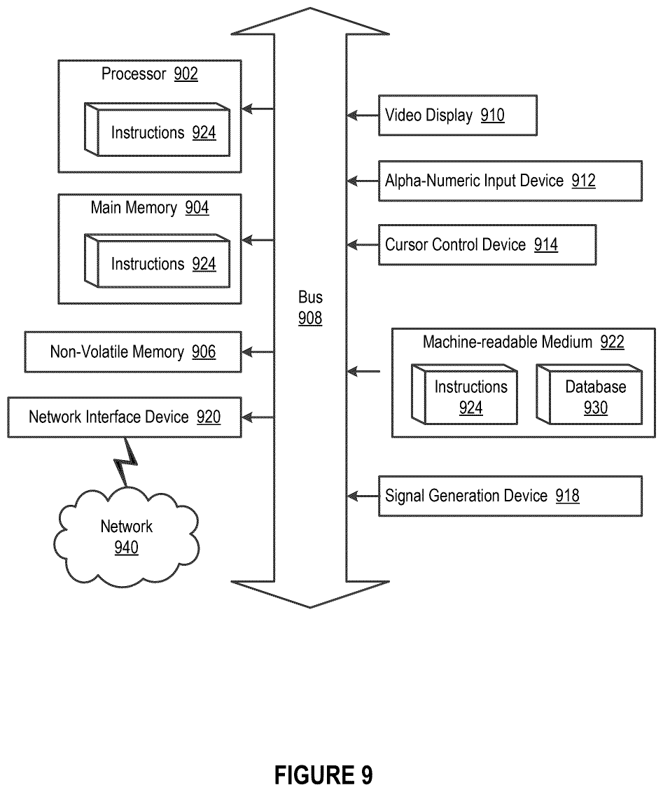

FIG. 9 illustrates an example of a computer system 900 that may be used to implement one or more of the embodiments of the present technology. For example, the computer system 900 can be implemented as a server, server system, or other type of computing system of the retrieval augmented generation (RAG) management system 102, the system 100, the data management service (DMS) 810, the computing system 805, the cloud environment 895, or the computing device 815. The computer system 900 can be included in a wide variety of local and remote machine and computer system architectures and in a wide variety of network and cloud computing environments that can implement the functionalities of the present technology. The computer system 900 includes sets of instructions 924 for causing the computer system 900 to perform the functionality, features, and operations discussed herein. The computer system 900 may be connected (e.g., networked) to other machines and/or computer systems. In a networked deployment, the computer system 900 may operate in the capacity of a server or a client machine in a client-server network environment, or as a peer machine in a peer-to-peer (or distributed) network environment.

The computer system 900 includes a processor 902 (e.g., a central processing unit (CPU), a graphics processing unit (GPU), or both), a main memory 904, and a nonvolatile memory 906 (e.g., volatile RAM and non-volatile RAM, respectively), which communicate with each other via a bus 908. In some embodiments, the computer system 900 can be a desktop computer, a laptop computer, personal digital assistant (PDA), or mobile phone, for example. In one embodiment, the computer system 900 also includes a video display 910, an alphanumeric input device 912 (e.g., a keyboard), a cursor control device 914 (e.g., a mouse), a signal generation device 918 (e.g., a speaker) and a network interface device 920.

In one embodiment, the video display 910 includes a touch sensitive screen for user input. In one embodiment, the touch sensitive screen is used instead of a keyboard and mouse. A machine-readable medium 922 can store one or more sets of instructions 924 (e.g., software) embodying any one or more of the methodologies, functions, or operations described herein. The instructions 924 can also reside, completely or at least partially, within the main memory 904 and/or within the processor 902 during execution thereof by the computer system 900. The instructions 924 can further be transmitted or received over a network 940 via the network interface device 920. In some embodiments, the machine-readable medium 922 also includes a database 930.

The processor 902 can be, for example, a hardware based integrated circuit (IC) or any other suitable processing device configured to run or execute a set of instructions or a set of codes. For example, the processor 902 can include a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like.

The network 940, which can represent the network 820, can be, for example, a digital telecommunication network of servers and/or computing devices. The servers and/or computing device on the network can be connected via one or more wired or wireless communication networks (not shown) to share resources such as, for example, data storage and/or computing power. The wired or wireless communication networks between servers and/or computing devices of the network can include one or more communication channels, for example, a radio frequency (RF) communication channel(s), an extremely low frequency (ELF) communication channel(s), an ultra-low frequency (ULF) communication channel(s), a low frequency (LF) communication channel(s), a medium frequency (MF) communication channel(s), an ultra-high frequency (UHF) communication channel(s), an extremely high frequency (EHF) communication channel(s), a fiber optic communication channel(s), an electronic communication channel(s), a satellite communication channel(s), and/or the like. The network can be, for example, the Internet, an intranet, a local area network (LAN), a wide area network (WAN), a metropolitan area network (MAN), a worldwide interoperability for microwave access network (WiMAX®), any other suitable communication system, and/or a combination of such networks.

The network 940 can use standard communications technologies and protocols. Thus, the network can include links using technologies such as Ethernet, 902.11, worldwide interoperability for microwave access (WiMAX®), 3G, 4G, 5G, CDMA, GSM, LTE, digital subscriber line (DSL), etc. Similarly, the networking protocols used on the network can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 906 may also be a random access memory. The non-volatile memory 906 can be a local device coupled directly to the rest of the components in the computer system 900. A non-volatile memory that is remote from the system, such as a network storage device coupled to any of the computer systems described herein through a network interface such as a modem or Ethernet interface, can also be used.

While the machine-readable medium 922 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 900 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in the same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine or computer-readable media used to actually affect the distribution.

Some embodiments described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java™, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java™, C++, etc.) or other suitable programming languages and/or development tools. Additional examples of computer code include, but are not limited to, control signals, encrypted code, and compressed code.

For purposes of explanation, numerous specific details are set forth in order to provide a thorough understanding of the description. It will be apparent, however, to one skilled in the art that embodiments of the present technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in some embodiments,” “in various embodiments,” “in an example,” “in one implementation,” “in one instance,” “in some instances,” or the like means that a particular feature, design, structure, or characteristic described in connection with the embodiment is included in at least one embodiment of the present technology. The appearances of, for example, the phrases “according to an embodiment,” “in one embodiment,” “in an embodiment,” “in some embodiments,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the present technology of the embodiments of the invention is intended to be illustrative, but not limiting, of the scope of the invention, which is set forth in the following claims.

What is claimed is:

1. A computer-implemented method comprising:
receiving, by a computing system, an embedding vector associated with first data;
permuting, by the computing system, the embedding vector to generate a permuted embedding vector; and
providing, by the computing system, the permuted embedding vector to a vector database.

2. The computer-implemented method of claim 1, wherein the permuted embedding vector is associated with content from a knowledge store, the method further comprising:
providing the permuted embedding vector to be maintained in the vector database.

3. The computer-implemented method of claim 1, wherein the permuted embedding vector is associated with a query, the method further comprising:
providing the permuted embedding vector for a search of the vector database.

4. The computer-implemented method of claim 1, further comprising:
acquiring a seed of a plurality of seeds, each seed associated with a corresponding permutation, wherein embedding vectors associated with content from a knowledge store and an embedding vector associated with a query are permuted in the same manner based on the acquired seed.

5. The computer-implemented method of claim 4, further comprising:
encrypting the acquired seed; and storing the encrypted acquired seed independently from the vector database.

6. The computer-implemented method of claim 4, wherein the acquired seed is randomly generated.

7. The computer-implemented method of claim 1, wherein the first data and second data are associated with at least one of different accounts, different domains, or different chatbots, and a permutation associated with a seed is applied to embedding vectors associated with the first data and the second data.

8. The computer-implemented method of claim 1, wherein the first data and second data are associated with at least one of different accounts, different domains, or different chatbots, a first permutation associated with a first seed is applied to embedding vectors associated with the first data, and a second permutation associated with a second seed is applied to embedding vectors associated with the second data.

9. The computer-implemented method of claim 1, wherein the first data is associated with at least one of textual information, visual information, or audio information.

10. The computer-implemented method of claim 1, further comprising:
determining metadata associated with a resulting permuted embedding vector from the vector database that is responsive to a query;
determining content associated with the resulting permuted embedding vector based on the metadata; and
utilizing the content in a prompt for provision to a large language model.

11. A system comprising:
at least one processor; and
a memory storing instructions that, when executed by the at least one processor, cause the system to perform operations comprising:
receiving an embedding vector associated with first data;
permuting the embedding vector to generate a permuted embedding vector; and
providing the permuted embedding vector to a vector database.

12. The system of claim 11, wherein the permuted embedding vector is associated with content from a knowledge store, the operations further comprising:
providing the permuted embedding vector to be maintained in the vector database.

13. The system of claim 11, wherein the permuted embedding vector is associated with a query, the operations further comprising:
providing the permuted embedding vector for a search of the vector database.

14. The system of claim 11, wherein the operations further comprise:
acquiring a seed of a plurality of seeds, each seed associated with a corresponding permutation, wherein the permuting is based on the acquired seed.

15. The system of claim 14, wherein the operations further comprise:
encrypting the acquired seed; and
storing the encrypted acquired seed independently from the vector database.

16. A non-transitory computer-readable storage medium including instructions that, when executed by at least on processor of a computing system, cause the computing system to perform operations comprising:
receiving an embedding vector associated with first data;
permuting the embedding vector to generate a permuted embedding vector; and
providing the permuted embedding vector to a vector database.

17. The non-transitory computer-readable storage medium of claim 16, wherein the permuted embedding vector is associated with content from a knowledge store, the operations further comprising:
providing the permuted embedding vector to be maintained in the vector database.

18. The non-transitory computer-readable storage medium of claim 16, wherein the permuted embedding vector is associated with a query, the operations further comprising:
providing the permuted embedding vector for a search of the vector database.

19. The non-transitory computer-readable storage medium of claim 16, wherein the operations further comprise:
acquiring a seed of a plurality of seeds, each seed associated with a corresponding permutation, wherein the permuting is based on the acquired seed.

20. The non-transitory computer-readable storage medium of claim 19, wherein the operations further comprise:
encrypting the acquired seed; and
storing the encrypted acquired seed independently from the vector database.
